(19) United States
(12) Patent Application Publication
(10) Pub. No.: US 2020/0358208 A1
(43) Pub. Date: Nov. 12, 2020

(54) GROUND CLAMP

(71) Applicant: R U GROUNDED ENERGY INC., Penhold (CA)

(72) Inventor: Terry D. MUNDLE, Stony Plain (CA)

(21) Appl. No.: 15/930,266

(22) Filed: May 12, 2020

Related U.S. Application Data
(60) Provisional application No. 62/846,717, filed on May 12, 2019.

(51) Int. Cl. H01R 4/66; H01R 4/36

(52) U.S. Cl. CPC H01R 4/66; H01R 4/36

(57) ABSTRACT

A ground clamp comprises an electrically-conductive main member with outwardly-projecting upper and lower flanges. One or more lugs or abutments (which may have pointed tips) project upward from the lower flange, and a bolt rotatably engages a threaded hole or nut on the upper flange, such that the lower end of the bolt stem is oriented toward the lower flange. The lower end of the bolt stem has a concave recess with a sharp-edged circumferential rim. When a conductive element of a structure or equipment unit requiring grounding is disposed between the lugs and the bolt stem, rotation of the bolt will clamp the conductive element between the lugs and the bolt stem, with the bolt stem's sharp-edged circumferential rim tending to rotatingly penetrate any surficial contaminants on conductive element, thus establishing or enhancing electrically-conductive contact with sound metal beneath the surficial contamination on the conductive element.

### FIELD OF THE DISCLOSURE

The present disclosure relates in general to electrical grounding devices for use in either permanent or temporary installations, and relates in particular to devices for making secure electrically-conductive connections to equipment or structures that need to be grounded.

### BACKGROUND

For reasons well known to persons skilled in the art, it is commonly necessary to provide either permanent or temporary electrical connections between metal structures (such as but not limited to buildings and large pieces of equipment) and the earth. This is most commonly done by providing an electrically-conductive connection between the structure to be grounded and a grounding device that penetrates the earth, or is buried underground, or is otherwise in contact with the earth in such a way that electrical current can flow between the grounding element and the earth. Common types of grounding devices include grounding rods (typically 8 to 10 feet long) that are driven or augered completely or almost completely into the earth. Other examples of known grounding devices are disclosed in U.S. Pat. No. 8,420,929 (Mundle), U.S. Pat. No. 9,083,171 (Mundle), U.S. Pat. No. 9,537,229 (Mundle), and U.S. Pat. No. 10,263,348 (Mundle).

The most common way to provide a temporary electrically-conductive connection between a structure and a grounding device is to use a grounding cable having suitable connection means at each end, which in some cases can be in the form of simple alligator clips, but in other cases might need to be something more secure, such as a bolted connection, to protect against the risk of inadvertent disconnection and a resultant loss of grounding effectiveness.

It is also commonly desirable to be able to connect grounding cables to a grounding device with minimal or no risk of sparking. This is particularly the case where flammable liquids or gases may be present in the vicinity, such as in various kinds of operations in the oil and gas industry. One example of this would be where it is necessary to temporarily ground an oil storage tank.

U.S. Pat. No. 7,946,862 discloses an electrically-conductive and generally C-shaped bracket having a bolt rotatably extending through a tapped hole in one segment of the bracket, with an opposing segment of the bracket having one or more sharply-pointed protrusions opposite the bolt. The bracket can be placed over an electrically-conductive element of a structure or equipment unit requiring grounding—for example, a steel flange on an oil storage tank—such that rotation of the bolt will clamp the flange (or other conductive element) between the substantially flat end of the bolt stem and the pointed protrusions on the opposing bracket segment. This will ground the tank (or other structure or equipment unit) when the bracket is connected to a grounding device by suitable means such as a grounding cable.

A drawback to the device in U.S. Pat. No. 7,946,862 is that the electrical conductivity necessary for effective grounding must be established via contact between the end of the bolt stem and the clamped conductive element and/or between the clamped conductive element and the sharply-pointed protrusions. Effective electrical conductivity may be difficult to achieve with sufficient reliability if the conductivity is impeded by rust, mill scale, or other contamination on the contacting surface of the conductive element being contacted and clamped by the substantially flat end of the bolt stem.

### BRIEF SUMMARY

The present disclosure teaches a ground clamp that works in a fashion generally similar to the device in U.S. Pat. No. 7,946,862, but with the notable distinction that it uses a bolt in which the end of the bolt stem is concave, creating a substantially circular cavity having a sharp circumferential edge.

### BRIEF DESCRIPTION OF THE DRAWINGS

Embodiments in accordance with the present disclosure will now be described with reference to the accompanying Figures, in which numerical references denote like parts, and in which:

FIG. 1 is an isometric view of one embodiment of a ground clamp in accordance with the present disclosure.

FIG. 2 is a side elevation of the ground clamp in FIG. 1.

FIG. 2A is a partially-sectioned detail of the lower end of the bolt stem of the ground clamp in FIG. 1, illustrating the concave recess on the lower end of the bolt stem and the sharp-edged circumferential rim around the concave recess.

### DESCRIPTION

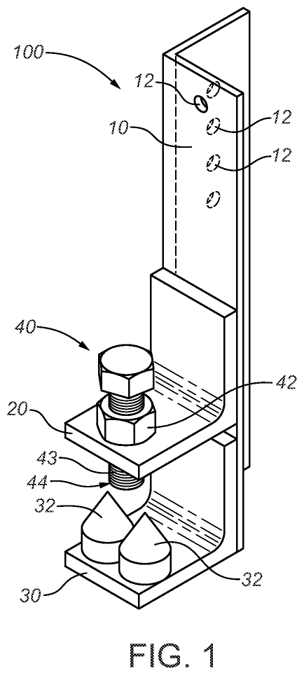

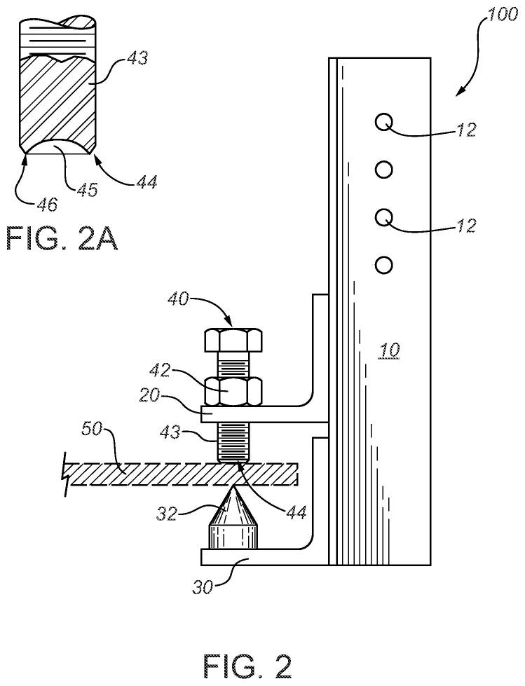

FIGS. 1, 2, and 2A illustrate an embodiment of a ground clamp 100 in accordance with the present disclosure. In the illustrated embodiment, ground clamp 100 comprises an electrically-conductive main member 10 (shown by way of non-limiting example in the form of an angle iron) with upper and lower flanges 20 and 30 projecting outward from the same side of main member 10, with at least upper flange 20 being made from an electrically-conductive material, and being conductively connected to main member 10. Main member 10 may have one or more holes 12 to facilitate a secure connection to a grounding cable.

In the illustrated embodiment, sharply-pointed lugs 32 project upward from lower flange 30 toward upper flange 20. However, this is by way of non-limiting example only; in alterative embodiments, the illustrated sharply-pointed lugs could be replaced (by way of non-limiting example) by lugs having comparatively less blunt points, or by non-pointed lugs or abutments that optionally may have substantially flat surfaces, which optionally may be textured for slip resistance (e.g., by knurling) to promote retention of a clamped conductive element by ground clamp 100 without sliding relative thereto. Preferably, but not necessarily, lower flange 30 and lugs 32 may be made from an electrically-conductive material and connected (by welding, for instance) such that lugs 32 are conductively connected to main member 10.

An electrically-conductive bolt 40 rotatably engages an electrically-conductive nut 42 which is fixed (such as by welding) to upper flange 20, with the stem 43 of bolt 40 projecting through an opening in upper flange 20 such that lower end 44 of bolt stem 43 is directed downward toward lower flange 30. In alternative embodiments, upper flange 20 could have a tapped hole for threadingly receiving bolt 40, instead of using a nut 42. Bolt 40 is electrically-conductively connected to main member 10 via its threaded engagement (either direct or via nut 42) with upper flange 20.

As best seen in FIG. 2A, lower end 44 of bolt stem 43 is formed with a downward-oriented concave recess 45, so as to form a sharp-edged circumferential rim 46. It will be readily appreciated with reference to FIG. 2 in particular that when a steel flange or other electrically-conductive element (schematically shown in FIG. 2 and designated by reference number 50) is disposed between lugs 32 and lower end 44 of bolt stem 43, rotation of bolt 40 so as to move lower end 44 of bolt stem 43 downward will cause conductive element 50 to become clamped between lugs 32 and lower end 44 of bolt stem 43, with sharp-edged circumferential rim 46 on bolt stem 43 tending to rotatingly penetrate any rust, mill scale, or other contaminants that might be present on the surface of conductive element 50, so as to establish improved electrically-conductive contact with sound metal beneath the surface contamination on element 50. Even if conductive element 50 is relatively free of surface contamination, the electrically-conductive effectiveness will tend to be improved over similar prior art devices by virtue of the greater extent of sharp-edged metal-to-metal contact and penetration achieved using concave-ended bolt 40.

All of the components of ground clamp 100 may be made from electrically-conductive materials, and that may typically be the preferred method of manufacture. As previously noted, however, it is not essential in all embodiments for lower flange 30 and lugs 32 to be electrically-conductive. In some embodiments, all or some components of ground clamp 100 may be made from stainless steel. In some embodiments, all or some components of ground clamp 100 may be made from a hardened steel.

It will be readily appreciated by those skilled in the art that various alternative embodiments of ground clamp apparatus disclosed herein may be devised without departing from the scope of the present teachings, including modifications that may use equivalent structures or materials subsequently conceived or developed. It is especially to be understood that it is not intended for ground clamp apparatus in accordance with the present disclosure to be limited to any described or illustrated embodiment, and that the substitution of a variant of a claimed element or feature, without any substantial resultant change in the working of the apparatus, will not constitute a departure from the scope of this disclosure.

In this patent document, any form of the word “comprise” is to be understood in its non-limiting sense to mean that any element or feature following such word is included, but elements or features not expressly mentioned are not excluded. A reference to an element or feature by the indefinite article “a” does not exclude the possibility that more than one such element or feature is present, unless the context clearly requires that there be one and only one such element or feature.

Any use of any form of the words “connect”, “engage”, “couple”, “attach”, or any other term describing an interaction between elements is not intended to limit that interaction to direct interaction between the elements in question, and may also include indirect interaction between the elements such as through secondary or intermediary structure.

In this document, the term “ground” and forms thereof may used in both noun and verb forms with reference to electrical grounding and electrical ground connections. The term “ground” may also be used herein with reference to earthen materials (e.g., soil) or a surface of the earth. The intended meaning of any form of the word “ground” in a given instance will be readily apparent to persons skilled in the art, having due regard to the context in which it is used.

What is claimed is:

1. A ground clamp comprising:
(a) an electrically-conductive main member;
(b) a lower upper flange projecting outward from the main member;
(c) an electrically-conductive upper flange projecting outward from the main member such that the upper flange is above the lower flange, and such that the upper flange is conductively connected to the main member;
(d) one or more lugs or abutments projecting upward from the lower flange; and
(e) an electrically-conductive bolt having a bolt stem, wherein:
the bolt is rotatably engageable within a threaded hole or nut associated with the upper flange, such the bolt is conductively connected to the upper flange and thereby to the main member;
the lower end of the bolt stem is oriented toward the lower flange; and
the lower end of the bolt stem has a downward-oriented concave recess having a sharp-edged circumferential rim;
such that when a conductive element of a structure or equipment unit requiring grounding is disposed between the lugs and the lower end of the bolt stem, rotation of the bolt will cause the conductive element to become clamped between the lugs and the bolt stem, with the bolt stem's sharp-edged circumferential rim rotatingly penetrating the surface of the conductive element to establish electrically-conductive connection therewith, and thereby establishing electrically-conductive connection between the conductive element and the main member.

2. A ground clamp as in claim 1 wherein one or more components of the ground clamp are made from a conductive material selected from the group consisting of carbon steels, stainless steels, and hardened steels.

3. A ground clamp as in claim 1 wherein one or more of the one or more lugs have sharply-pointed tips.

4. A ground clamp as in claim 1 wherein the tips of one or more of the one or more lugs have substantially flat surfaces.

5. A ground clamp as in claim 4 wherein the substantially flat surfaces of the lugs are textured for slip resistance.
